(19) United States
(12) Patent Application Publication
(10) Pub. No.: US 2011/0295524 A1
(43) Pub. Date: Dec. 1, 2011

(54) DETERMINING APPARATUS AND DETERMINING METHOD

(75) Inventors: Yoshiaki Tada, Kawasaki (JP); Naoya Yamazaki, Kawasaki (JP); Kazuhiro Iino, Kawasaki (JP); Takashi Shirakami, Kawasaki (JP)

(73) Assignee: FUJITSU LIMITED, Kawasaki-shi (JP)

(21) Appl. No.: 13/109,596

(22) Filed: May 17, 2011

(30) Foreign Application Priority Data
May 26, 2010 (JP) 2010-120555

(51) Int. Cl. G06F 19/00

(52) U.S. Cl. 702/45

(57) ABSTRACT

A determining method includes: holding a cooled device in a container; detecting a temperature inside the container; detecting a temperature outside the container; facilitating a airflow through an air filter that allows air to flow therethrough between the container and a space outside the container; calculating a packing density of components of the cooled device; detecting a power consumption of the cooled device; detecting the number of revolutions of a fan that facilitates the flow of air through the air filter; and determining that the air filter is clogged when the power consumption is less than or equal to a power threshold value, the number of revolutions is within a specified range, and a difference between the temperature inside the container and the temperature outside the container exceeds a temperature threshold value that depends on the packing density and the power consumption.

### CROSS-REFERENCE TO RELATED APPLICATIONS

This application is based upon and claims the benefit of priority from the prior Japanese Patent Application No. 2010-120555 filed on May 26, 2010, the entire contents of which are incorporated herein by reference.

### FIELD

The embodiments discussed herein are related to an apparatus and a method for determining a state of an air filter.

### BACKGROUND

In an apparatus where plug-in units (PIUs) are mounted in a bookshelf-type housing, a fan is provided to release heat generated inside the apparatus to the outside. An air supply and exhaust opening of the apparatus is provided with an air filter (filter) that prevents dust from entering the apparatus. The air filter may be clogged after a long period of operation of the fan. Clogging of the air filter makes it difficult to release heat inside the apparatus to the outside even during operation of the fan. If heat inside the apparatus is not released to the outside, the temperature inside the apparatus rises. A temperature rise inside the apparatus may cause functional deterioration or failure of the apparatus. Therefore, it is desirable that the clogging of the air filter be precisely detected and addressed.

Related techniques are disclosed, for example, in Japanese Laid-open Patent Publication No. 2002-357317 and Japanese Laid-open Patent Publication No. 58-000200.

### SUMMARY

According to an aspect of the invention, a determining method includes: holding a cooled device in a container; detecting a temperature inside the container; detecting a temperature outside the container; facilitating a airflow through an air filter that allows air to flow therethrough between the container and a space outside the container; calculating a packing density of components of the cooled device; detecting a power consumption of the cooled device; detecting the number of revolutions of a fan that facilitates the flow of air through the air filter; and determining that the air filter is clogged when the power consumption is less than or equal to a power threshold value, the number of revolutions is within a specified range, and a difference between the temperature inside the container and the temperature outside the container exceeds a temperature threshold value that depends on the packing density and the power consumption.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an abnormality detecting system,

FIG. 2 illustrates a first part of an operation flow of the abnormality detecting system,

FIG. 3 illustrates a second part of the operation flow of FIG. 2,

FIG. 4 is a graph showing determination criteria stored, for each PIU, in a storage unit,

FIG. 5 illustrates an alert in a communication apparatus,

FIG. 6 is a graph showing a relationship between a power consumption of one PIU and a temperature difference between a temperature of the PIU and an environmental temperature,

FIG. 7 illustrates how power consumption, temperature difference, and temporal differentiation of power consumption change with time when there is a sudden change in power consumption,

FIG. 8 illustrates an example where a plurality of communication apparatuses each having a filter are managed by a central network management terminal.

### DESCRIPTION OF EMBODIMENTS

It is difficult to directly detect clogging of an air filter. For example, clogging of an air filter may be detected by measuring an air speed near the air filter with an air speed sensor which is installed near the air filter. However, detecting clogging of the air filter with the air speed sensor is disadvantageous in that a space for installation of the air speed sensor is required, and that the air speed sensor tends to make erroneous detection.

Clogging of an air filter may be detected by measuring an internal temperature. However, in an apparatus where PIUs are mounted, possible changes in mounting states of the PIUs may affect the temperature inside the apparatus. This is because mounting states of the PIUs may have an impact on the flow of air inside the apparatus. Typically, a plurality of components is mounted on each PIU. A mounting state of the PIU includes the arrangement, sizes, and packing density of components on the PIU. Therefore, a condition, such as an internal temperature, under which the air filter is clogged varies depending on the mounting states of PIUs.

Embodiments will now be described with reference to the drawings. Note that configurations of the embodiments are merely examples and are not limited to those disclosed herein.

An abnormality detecting system of the present embodiment includes an abnormality detecting device, PIUs, a fan unit, a filter unit, and an environmental-temperature detecting unit. Each of the PIUs includes a temperature detector and a power consumption detector. The abnormality detecting device detects clogging of a filter on the basis of information on an environmental temperature, a rotational state of a fan, a mounting state of each PIU, a temperature of each PIU, and a power consumption of each PIU, for example.

Here, for example, the abnormality detecting system is included in a communication apparatus where electronic circuit boards are mounted in a bookshelf-type housing having a plurality of slots. The electronic circuit boards are mounted as PIUs in the slots of the housing.

For example, if the communication apparatus is a transmission apparatus, a plurality of types of PIUs, such as an external interface PIU, a frame exchange PIU, and an apparatus monitoring control PIU, are mounted in the transmission apparatus.

The external interface PIU is capable of, for example, performing reception processing on a signal received from another transmission apparatus, converting the received signal into an internal signal of the own apparatus, and outputting the internal signal. The external interface PIU is also capable of, for example, receiving an internal signal, converting the internal signal into a signal to be transmitted to another transmission apparatus, and outputting the resulting signal.

The frame exchange PIU is capable of, for example, performing exchange processing on internal signals from a plurality of external interface PIUs, and outputting the resulting signals to the plurality of external interface PIUs.

The apparatus monitoring control PIU is capable of, for example, monitoring and controlling each of the PIUs described above.

The abnormality detecting system of the present embodiment can be included in any apparatus having a housing with a filter that inhibits and/or prevents entry of dust.

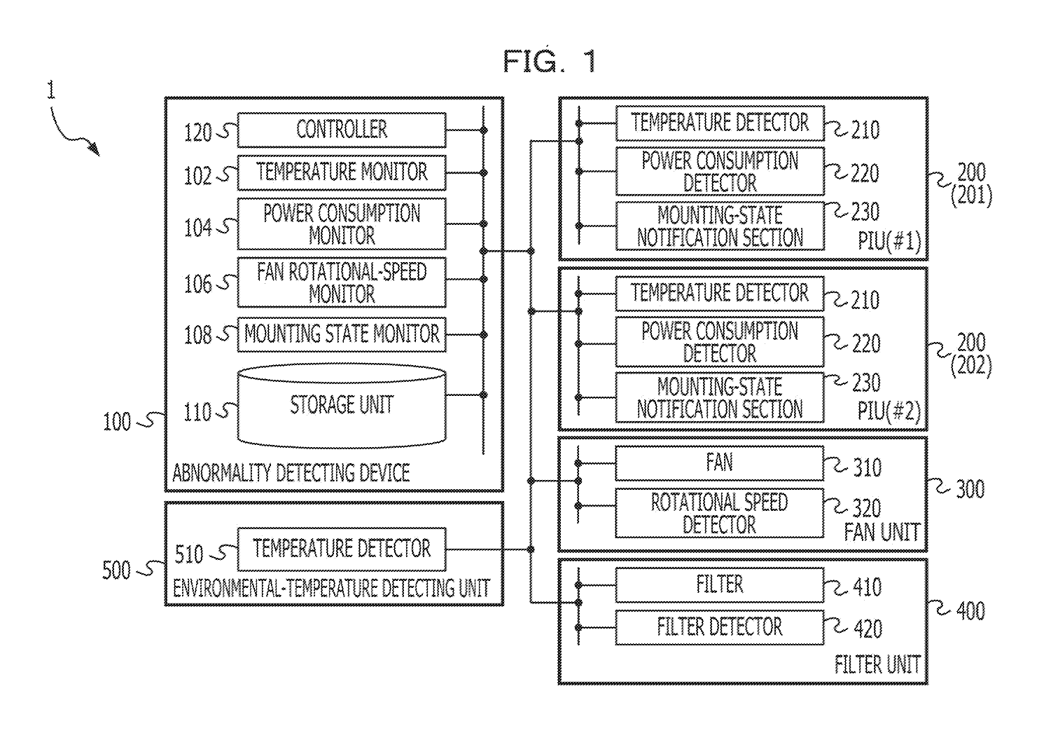

FIG. 1 illustrates an abnormality detecting system according to the present embodiment. PIUs are removably mounted in slots of a bookshelf-type housing.

An abnormality detecting system 1 includes an abnormality detecting device 100, PIUs 200, a fan unit 300, a filter unit 400, and an environmental-temperature detecting unit 500. Although the abnormality detecting system 1 includes two PIUs (a PIU (#1) 201 and a PIU (#2) 202) here, the number of the PIUs 200 is not limited to two. For example, the number of the PIUs 200 that can be mounted in the abnormality detecting system 1 can be set to any value greater than or equal to one. The abnormality detecting system 1 may include a plurality of fan units or a plurality of filter units. The PIUs 200 each are a cooled device cooled by a fan 310.

The abnormality detecting device 100 includes a temperature monitor 102, a power consumption monitor 104, a fan rotational-speed monitor 106, a mounting state monitor 108, a storage unit 110, and a controller 120. The abnormality detecting device 100 may be mounted as a unit in a slot of the bookshelf-type housing. Alternatively, the abnormality detecting device 100 may be included as a function of a common control unit of the communication apparatus. A slot is a container that holds each PIU 200.

The temperature monitor 102 obtains a temperature of each PIU 200 from a temperature detector 210 in the PIU 200, and also obtains an environmental temperature from a temperature detector 510 in the environmental-temperature detecting unit 500.

The power consumption monitor 104 obtains a power consumption of each PIU 200 from a power consumption detector 220 in the PIU 200.

The fan rotational-speed monitor 106 obtains the number of revolutions of the fan 310 from a rotational speed detector 320 in the fan unit 300.

The mounting state monitor 108 obtains information on a mounting state of each PIU 200 from a mounting-state notification section 230 in the PIU 200. A mounting state of the PIU 200 is, for example, a packing density (or filling rate) of the PIU 200. The packing density of the PIU 200 can be obtained as a ratio of a sum of volumes of a substrate and components of the PIU 200 to a volume of space that can be occupied by the PIU 200 mounted in a slot. In other words, a packing density of the PIU 200 is a ratio of a volume of components of the PIU 200 to a volume occupied by the PIU 200. A packing density can be calculated by the mounting state monitor 108 or the controller 120. The mounting state of the PIU 200 may include information on whether the PIU 200 is mounted and a position where the PIU 200 is mounted. The mounting state of the PIU 200 may also include a mounting state of another PIU 200 in a neighboring slot. A flow of gas (typically air) inside the housing can be changed depending on the mounting state. For example, if the density of components on the PIU 200 adjacent to the own PIU 200 is high, gas flows easily around the own PIU 200. The mounting state monitor 108 can notify the filter detector 420 in the filter unit 400 of whether a filter 410 is mounted. The mounting state of the PIU 200 may be draft resistance in the neighboring slot of the PIU 200. The draft resistance is a measure of how difficult it is for gas to pass through. The draft resistance is highest when the slot is filled up, and is lowest when nothing is present in the slot. If draft resistance in the neighboring slot of the PIU 200 is high, gas can easily pass through the PIU 200. If draft resistance in the neighboring slot of the PIU 200 is low, gas cannot easily pass through the PIU 200.

The temperature monitor 102, the power consumption monitor 104, the fan rotational-speed monitor 106, and the mounting state monitor 108 may operate as an obtaining unit.

The storage unit 110 stores temperature and other information obtained by the temperature monitor 102 etc. The storage unit 110 also stores data, as a database, for determining whether the filter 410 is clogged etc. The storage unit 110 may store, for each PIU 200, a table that associates an identification code of the PIU 200 with information on the sum of volumes of the substrate and components of the PIU 200 (i.e., information on the volume of the PIU 200).

The controller 120 controls the abnormality detecting system 1 and the abnormality detecting device 100. The controller 120 controls the temperature monitor 102, the power consumption monitor 104, the fan rotational-speed monitor 106, and the mounting state monitor 108 such that they obtain temperature information etc. On the basis of the temperature and other information obtained by the temperature monitor 102 etc. and the database stored in the storage unit 110, the controller 120 determines whether the filter 410 is clogged etc. The controller 120 can output an alert indicating that the filter 410 is clogged etc.

Each PIU 200 includes the temperature detector 210, the power consumption detector 220, and the mounting-state notification section 230. The PIU 200 is populated with a plurality of electronic components, such as large scale integrations (LSIs) each being obtained by forming an electronic circuit on a printed circuit board.

The temperature detector 210 measures a temperature of the PIU 200. In the PIU 200, the temperature detector 210 is positioned near electronic components that generate heat. The temperature detector 210 notifies the abnormality detecting device 100 of the measured temperature. A temperature sensor, such as a thermocouple, a platinum resistance temperature detector, or a thermistor, can be used as the temperature detector 210. Alternatively, a temperature sensor included in a component mounted on the PIU 200 may be used as the temperature detector 210.

The power consumption detector 220 measures power consumed by the PIU 200 (i.e., a power consumption of the PIU 200). The power consumption detector 220 notifies the abnormality detecting device 100 of information on the measured power consumption.

The mounting-state notification section 230 notifies the abnormality detecting device 100 of mounting state information, including the arrangement and volume of components of the PIU 200. For example, the mounting-state notification section 230 may store, in advance, information on volumes of a substrate and all components depending on the type of the PIU 200, and may notify the abnormality detecting device 100 of the stored information.

The mounting-state notification section 230 may store, for example, an identification code representing the type of the PIU 200 and notify the abnormality detecting device 100 of the stored identification code. In this case, for each type of the PIU 200, the abnormality detecting device 100 stores, in the storage unit 110 in advance, a table that associates the identification code of the PIU 200 with information on the volume of the PIU 200. The abnormality detecting device 100 can recognize the volume of the PIU 200 from the identification code received from the mounting-state notification section 230.

The fan unit 300 includes the fan 310 and the rotational speed detector 320. By turning the blades, the fan 310 supplies air to the inside of the housing and exhausts air to the outside of the housing. The rotational speed detector 320 detects the number of revolutions of the fan 310 per unit time. The rotational speed detector 320 may detect whether the fan 310 is rotating at low speed or high speed, for example.

The rotational speed detector 320 notifies the abnormality detecting device 100 of information on the detected number of revolutions of the fan 310 per unit time. The volume of air delivered by the fan 310 per unit time can be calculated from the number of revolutions of the fan 310 per unit time and the volume of air delivered by the fan 310 per revolution. The volume of air delivered by the fan 310 per revolution may be stored in the storage unit 110 in advance.

The filter unit 400 includes the filter 410 and the filter detector 420. The filter unit 400 is placed near an air supply opening so that the filter 410 can inhibit and/or prevent entry of dust. For easy removal of clogging or easy replacement, the filter 410 is positioned such that it can be removed from the filter unit 400.

The filter detector 420 detects whether the filter 410 is mounted. The filter detector 420 can be realized, for example, by a switch electrically connected thereto by mounting the filter 410.

The environmental-temperature detecting unit 500 includes the temperature detector 510. The temperature detector 510 measures the outside temperature (environmental temperature) of the housing which includes the PIUs 200, the fan unit 300, and the filter unit 400. The temperature detector 510 is positioned, for example, such that it can measure the temperature of air substantially immediately after the air is supplied to the housing. This is because the temperature of air immediately after the air is supplied to the housing is considered to be substantially the same as the temperature outside the housing. Alternatively, the temperature detector 510 may be placed outside the housing. A temperature sensor, such as a thermocouple, a platinum resistance temperature detector, or a thermistor, can be used as the temperature detector 510.

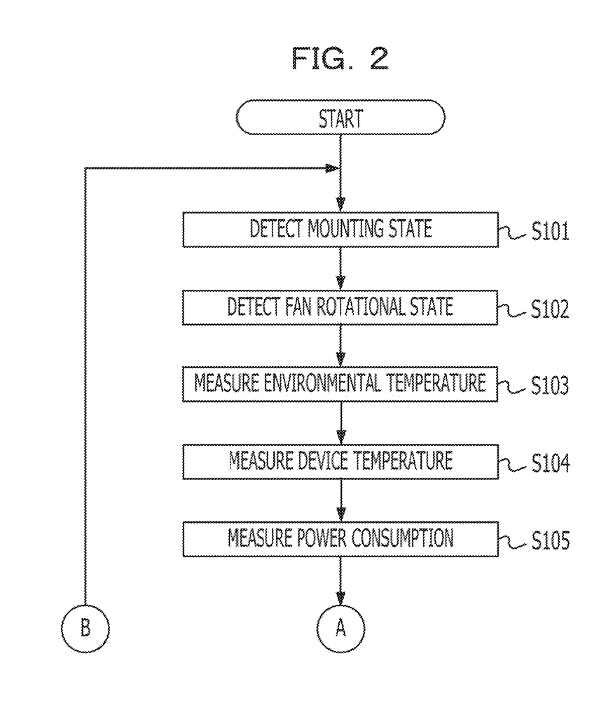

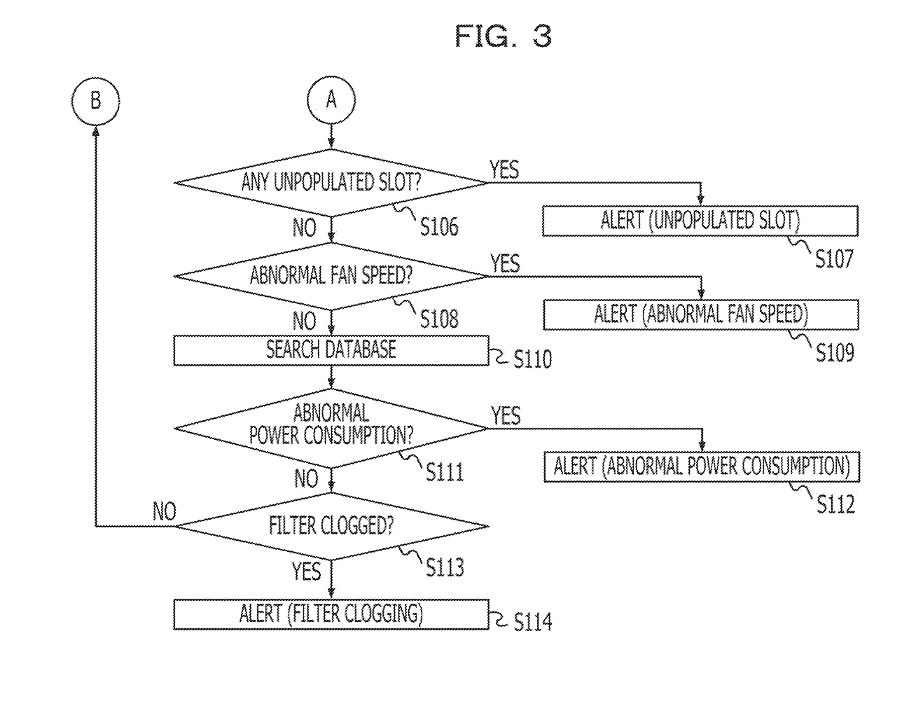

FIG. 2 and FIG. 3 illustrate an operation flow of the abnormality detecting system 1. The operation flow of FIG. 2 and FIG. 3 is started when, for example, a transmission apparatus is powered on (at “START” in FIG. 2). Note that “A” and “B” in FIG. 2 are connected to “A” and “B”, respectively, in FIG. 3.

The mounting state monitor 108 in the abnormality detecting device 100 detects a mounting state of the PIU 200 in each slot of the housing (step S101). The mounting state includes, for example, the presence or absence of the PIU 200 in the slot, and the density of components on the PIU 200. From the detected mounting state, the mounting state monitor 108 can calculate a packing density of the PIU 200 as a ratio of a sum of volumes of a substrate and components of the PIU 200 to a volume of space that can be occupied by the PIU 200 mounted in the slot.

An unpopulated slot in the housing of the communication apparatus may be filled with a filler. An unpopulated slot is a slot in which nothing is mounted. In principle, the communication apparatus is operated in a state where there is no unpopulated slot. The filler is shaped to fill up the space that can be occupied by a PIU mounted in the slot. Therefore, the packing density (filling rate) of the filler is about one. The slot filled with the filler does not allow gas to flow therethrough. This shape of the filler allows gas to easily flow through other PIUs around the filler.

The mounting state monitor 108 can recognize that the slot is filled with a filler, for example, on the basis of the state of electrical connection of the slot.

The fan rotational-speed monitor 106 requests information on the number of revolutions of the fan 310 per unit time from the rotational speed detector 320 in the fan unit 300. The rotational speed detector 320 measures the number of revolutions of the fan 310 per unit time. The rotational speed detector 320 transmits information on the measured number of revolutions per unit time to the fan rotational-speed monitor 106 (step S102). The rotational speed detector 320 may notify the fan rotational-speed monitor 106 of, for example, whether the fan 310 is rotating at low speed or high speed. Alternatively, the rotational speed detector 320 may be configured to always transmit the number of revolutions of the fan 310 per unit time to the fan rotational-speed monitor 106.

The temperature monitor 102 requests information on the environmental temperature from the temperature detector 510 in the environmental-temperature detecting unit 500. The temperature detector 510 measures the environmental temperature and transmits information on the measured temperature to the temperature monitor 102 (step S103). Alternatively, the temperature detector 510 may be configured to always transmit information on the environmental temperature to the temperature monitor 102.

Also, the temperature monitor 102 requests information on the temperature of each PIU 200 from the temperature detector 210 in the PIU 200. The temperature detector 210 measures the temperature of the PIU 200 and transmits information on the measured temperature to the temperature monitor 102 (step S104). Alternatively, the temperature detector 210 may be configured to always transmit the temperature information to the temperature monitor 102.

The power consumption monitor 104 requests information on the power consumption of each PIU 200 from the power consumption detector 220 in the PIU 200. The power consumption detector 220 measures the power consumption of the PIU 200 and transmits information on the measured power consumption to the power consumption monitor 104 (step S105). Alternatively, the power consumption detector 220 may be configured to always transmit the power consumption information to the power consumption monitor 104.

The controller 120 checks whether there is any unpopulated slot in the housing (step S106). An unpopulated slot is a slot in which nothing is mounted. The mounting state of the slot is recognized by the mounting state monitor 108. If there is any unpopulated slot (YES in step S106), the controller 120 outputs an alert indicating that there is an unpopulated slot (step S107). If there is no unpopulated slot (NO in step S106), the process proceeds to step S108.

The controller 120 checks whether the number of revolutions (or the rotational speed) of the fan 310 is abnormal (step S108). Specifically, for example, the controller 120 checks whether the number of revolutions of the fan 310 exceeds a threshold value, or is less than or equal to another threshold value. The number of revolutions of the fan 310 is recognized by the fan rotational-speed monitor 106. If the number of revolutions (or the rotational speed) of the fan 310 is abnormal (YES in step S108), the controller 120 outputs an alert indicating that the number of revolutions (or the rotational speed) of the fan 310 is abnormal (step S109). Since this corresponds to a determination that a temperature rise inside the housing is caused by a factor other than filter clogging, accuracy in notification of filter clogging is improved. In other words, this indicates that a temperature rise inside the housing is determined to be caused by an abnormality in the number of revolutions (or the rotational speed) of the fan 310, not by filter clogging. If the number of revolutions (or the rotational speed) of the fan 310 is normal (NO in step S108), the process proceeds to step S110.

For each PIU 200, the controller 120 searches a database stored in the storage unit 110, on the basis of the identification code of the PIU 200, the number of revolutions of the fan 310, and the mounting state (step S110), for example. The mounting state includes, for example, the packing density of a filler or PIU 200 mounted in a neighboring slot of the own PIU 200 and the packing density of the own PIU 200. The database provides determination criteria for determining whether the filter 410 is clogged etc. The determination criteria are criteria that depend on, for each PIU 200, the number of revolutions of the fan 310, the mounting state of the neighboring slot of the PIU 200, etc. For each PIU 200, determination criteria (database) obtained by simulation using various numbers of revolutions of the fan 310 and various mounting states of the neighboring slot of the PIU 200 are stored in the storage unit 110 in advance, for example. The controller 120 extracts determination criteria for the PIU 200 from the storage unit 110 by specifying, for example, the identification code of the PIU 200, the number of revolutions of the fan 310, and the packing density of a filler or PIU 200 mounted in the neighboring slot. Alternatively, the controller 120 may extract determination criteria for the PIU 200 from the storage unit 110 by specifying, for example, the identification code of the PIU 200 and the number of revolutions of the fan 310.

A maximum power consumption defined for each PIU 200 is also stored in the storage unit 110. The maximum power consumption defined for each PIU 200 is included in determination criteria, by which a determination can be made as to whether the communication apparatus operates properly, the filter 410 is clogged, and power consumption is abnormal.

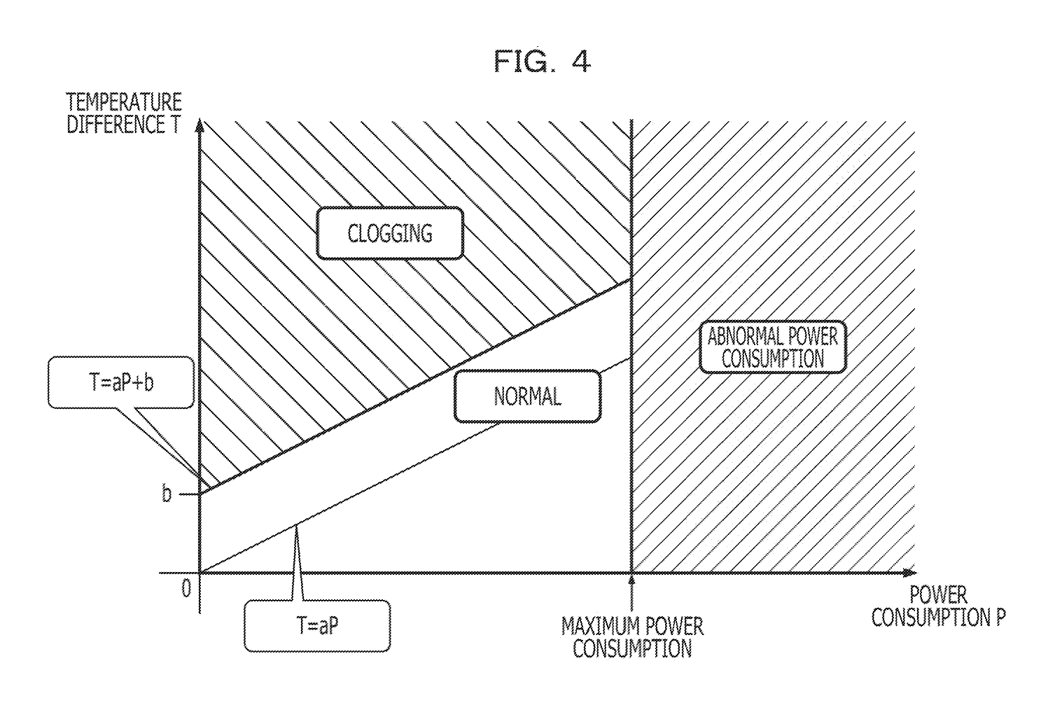

FIG. 4 is a graph showing determination criteria stored, for each PIU 200, in the storage unit 110, for example. In the graph of FIG. 4, the horizontal axis represents power consumption of the PIU 200, and the vertical axis represents a difference between the temperature of the PIU 200 and the environmental temperature (i.e., temperature difference). For each PIU 200, determination criteria obtained by simulation(s) using various numbers of revolutions of the fan 310 and various mounting states of the neighboring slot of the PIU 200 are stored in the storage unit 110 in advance. As determination criteria, for example, the storage unit 110 stores information on the maximum power consumption of the PIU 200, and information on a function representing a boundary between a range where the communication apparatus is determined to be normal and a range where the filter 410 is determined to be clogged.

When the PIU 200 operates properly, the power consumption of the PIU 200 is expected to be less than or equal to a maximum power consumption of the PIU 200. Therefore, if the power consumption of the PIU 200 exceeds the maximum power consumption, the power consumption is considered abnormal, regardless of the temperature of the PIU 200. The maximum power consumption of the PIU 200 may be determined in advance for each PIU 200.

Most of power consumed by the PIU 200 is converted to heat by electronic components of the PIU 200. Therefore, when heat inside the housing is properly exhausted to the outside, a temperature difference T between the temperature of the PIU 200 and the environmental temperature is proportional to a power consumption P of the PIU 200. If the power consumption of the PIU 200 is less than or equal to the maximum power consumption, the power consumption P of the PIU 200 and the temperature difference T between the temperature of the PIU 200 and the environmental temperature are in a proportional relationship as follows.

T=aP (1)

In the equation (1) above, “a” is a coefficient which increases the temperature difference per unit power consumption. The coefficient “a” is a constant determined in advance by simulation, for example. The coefficient “a” varies depending on the PIU 200, the number of revolutions of the fan 310, and the mounting state of the neighboring slot. For example, the coefficient “a” increases as the number of revolutions of the fan 310 decreases. This is because if the number of revolutions of the fan 310 is small, heat inside the housing cannot easily escape. For example, in setting determination criteria, the coefficient “a” set for the case where the number of revolutions of the fan 310 is greater than or equal to a value can be different from that for the case where the number of revolutions of the fan 310 is less than the value.

For example, the coefficient “a” is small when the neighboring slot of the PIU 200 is filled with a filler. Since the filler is shaped to fill up the space that can be occupied by a PIU mounted in a slot, gas cannot flow (or cannot easily flow) through the slot filled with the filler. Since this facilitates a flow of gas through the PIU 200 and allows heat to easily escape from inside the housing, the coefficient “a” is reduced. If another PIU 200 having many components is mounted in the neighboring slot, gas cannot easily flow through the neighboring slot and thus, the coefficient “a” is reduced. For example, in setting determination criteria, the coefficient “a” set for the case where the PIU 200 mounted in the neighboring slot has components with a volume greater than or equal to a certain volume can be different from that for the case where the PIU 200 mounted in the neighboring slot has components with a volume less than the certain volume. In other words, in setting determination criteria, the coefficient “a” set for the case where the packing density is higher than or equal to a certain value may be different from that for the case where the packing density is less than the certain value. The density of the PIU 200 mounted in the neighboring slot may be divided into ranges, for each of which a different coefficient “a” is set.

If the PIU 200 has many components and a large volume of the mounting space of the PIU 200 is occupied by the components, the coefficient “a” in determination criteria is greater than the case where the PIU 200 does not have many components. This is because if the PIU 200 has many components, gas cannot easily flow through the inside of the PIU 200, as compared to the case where the PIU 200 does not have many components.

If heat inside the housing is not properly exhausted to the outside, the temperature difference T between the temperature of the PIU 200 and the environmental temperature increases even when there is no change in power consumption P of the PIU 200. In this case, it is possible to determine that the filter 410 is clogged. In the example of FIG. 4, the filter 410 is determined to be clogged if the temperature difference T is greater than a value obtained by adding a temperature “b” to the temperature difference represented by the equation (1). The temperature “b” may be obtained in advance, for example, by simulation. Alternatively, the predetermined temperature “b” may be determined by the clogging level at which the filter 410 is determined to be clogged. That is, the filter 410 is determined to be clogged when the temperature difference T between the temperature of the PIU 200 and the environmental temperature satisfies the following inequality.

T>aP+b (2)

The communication apparatus is determined to be normal when the relationship between the power consumption P of the PIU 200 and the temperature difference T between the temperature of the PIU 200 and the environmental temperature is within a range where neither abnormal power consumption nor filter clogging is determined to occur. In this example, the coefficient “a” and the temperature “b” can indicate a boundary between the range where the filter 410 is determined to be clogged and the range where the communication apparatus is determined to be normal.

The determination criteria are generated, for each PIU 200 in advance, from various numbers of revolutions of the fan 310 and various mounting states of the neighboring slot, and stored in the storage unit 110. That is, the determination criteria may be generated, for each PIU 200 in advance, by varying the number of revolutions of the fan 310 and the mounting state of the neighboring slot, and stored in the storage unit 110. For example, if two different numbers of revolutions of the fan 310 and ten different mounting states of the neighboring slot are set, 20 (=2×10) different determination criteria may be generated for each PIU 200 in advance and stored in the storage unit 110.

Here, the neighboring slot refers to all slots in the communication apparatus except the own slot, or may refer to a slot closest to the own slot.

Referring back to FIG. 3, the controller 120 checks the power consumption of each PIU 200 (step S111). If the power consumption of the PIU 200 is greater than a maximum power consumption (YES in step S111), the controller 120 outputs an alert indicating that the power consumption of the PIU 200 is abnormal (step S112). The maximum power consumption is included in the determination criteria selected in step S110. The controller 120 determines whether the power consumption of each PIU 200 is abnormal. If the power consumption of at least one PIU 200 is abnormal, the controller 120 outputs an alert. Since this corresponds to a determination that a temperature rise inside the housing is caused by a factor other than filter clogging, accuracy in notification of filter clogging is improved. In other words, this means that a temperature rise inside the housing is determined to be caused by an abnormality in power consumption, not by filter clogging. If the power consumption of every PIU 200 is less than or equal to the maximum power consumption of the PIU 200 (NO in step S111), the process proceeds to step S113.

The controller 120 determines whether the filter 410 is clogged, by using determination criteria selected for each PIU 200 in step S110 (step S113). The controller 120 compares the temperature difference and the power consumption to the determination criteria selected for each PIU 200 to determine whether the filter 410 is clogged. For example, the controller 120 determines whether the filter 410 is clogged depending on whether the temperature difference T and the power consumption P satisfy the inequality (2).

In the determination for at least one PIU 200, if a relationship between the temperature difference and the power consumption is within a range (see FIG. 4) where the filter 410 is determined to be clogged (YES in step S113), the controller 120 outputs an alert indicating that the filter 410 is clogged (step S114). On the other hand, if the filter 410 is not determined to be clogged in the determination for any of the PIUs 200 (NO in step S113), the communication apparatus is determined to be normal and the process returns to step S101.

Note that the operations in step S101 to step S105 may be performed in any order. The operations in step S101 to step S105 may not necessarily be performed sequentially, but may be performed simultaneously.

The operation in step S106 may be performed at any time after the mounting state detection in step S101. For example, the operation in step S106 may be performed before the operation in step S102. Similarly, the operation in step S108 may be performed at any time after the detection of the rotational state of the fan 310 in step S102. For example, the operation in step S108 may be performed before the operation in step S103.

The operation in step S111 can be performed as long as a maximum power consumption of each PIU 200 is known. Therefore, when the controller 120 obtains a maximum power consumption of each PIU 200 from the storage unit 110, the operation in step S111 may be performed before the operation in step S110.

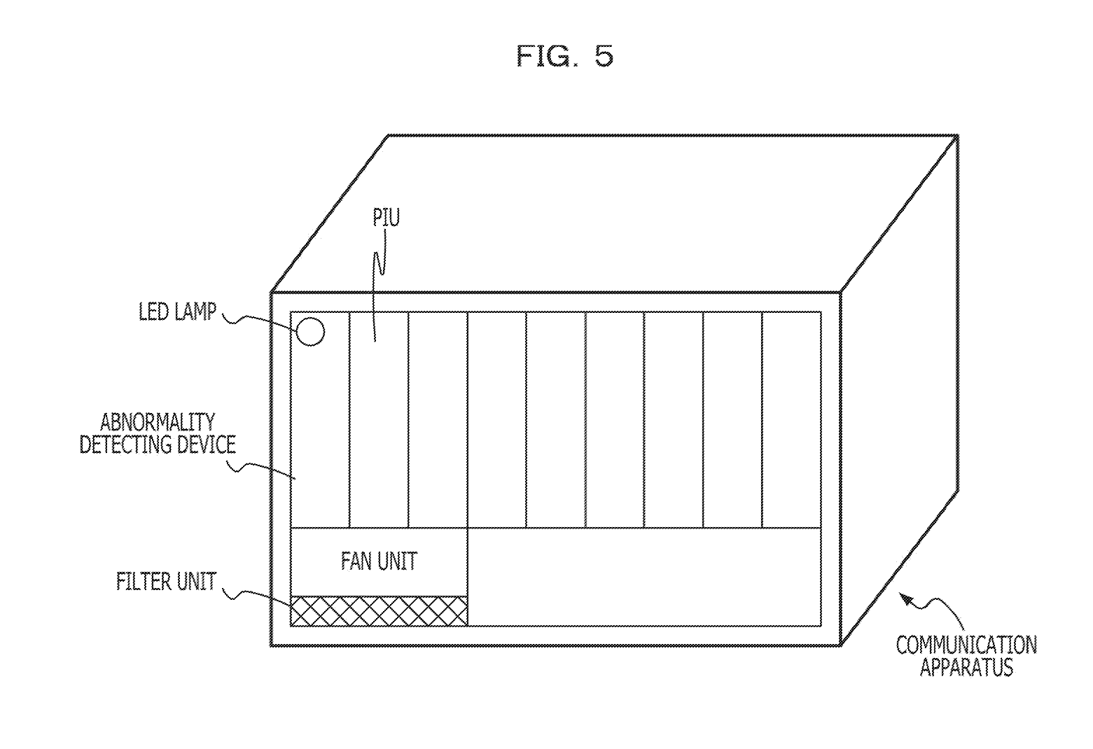

FIG. 5 illustrates an alert in the communication apparatus. Each alert output by the controller 120 in the abnormality detecting device 100 may be provided, for example, by a light-emitting diode (LED) lamp positioned toward the outside of the communication apparatus. For example, the communication apparatus can provide various alerts by using an LED lamp with multiple colors or by using multiple LED lamps.

The communication apparatus may have a speaker to provide a preset audio alert. Each alert output by the controller 120 may be transmitted from the abnormality detecting device 100 through a communication line to an external device.

In the abnormality detecting system 1 according to the present embodiment, the abnormality detecting device 100 obtains information on the temperature of each PIU 200, the power consumption of each PIU 200, the mounting state of each PIU 200, the number of revolutions of the fan 310, the presence or absence of the filter 410, and the environmental temperature. On the basis of the obtained information, the abnormality detecting device 100 detects filter clogging etc. The abnormality detecting device 100 outputs an alert upon detection of an abnormality, such as filter clogging. The abnormality detecting device 100 determines whether the filter 410 is clogged etc. by using determination criteria which depend on the mounting state of the PIU 200, the number of revolutions of the fan 310, etc. Additionally, the abnormality detecting device 100 determines whether the filter 410 is clogged etc. by using determination criteria which depend on the mounting state of another PIU 200 mounted in the neighboring slot.

According to the present embodiment, filter clogging can be detected by determining that there is no occurrence of abnormality caused by factors other than filter clogging. The abnormality detecting system 1 can accurately detect filter clogging even if the mounting state of each PIU 200 is changed. The abnormality detecting system 1 can detect filter clogging by taking into account the mounting state of the neighboring slot of the PIU 200. Also, the abnormality detecting system 1 can detect filter clogging without using an air speed sensor.

(First Modification)

The abnormality detecting system 1 will be described in which a sudden change in power consumption of the PIU 200 is taken into account. A description will be mainly given of differences from the example described above, and a redundant description will be omitted.

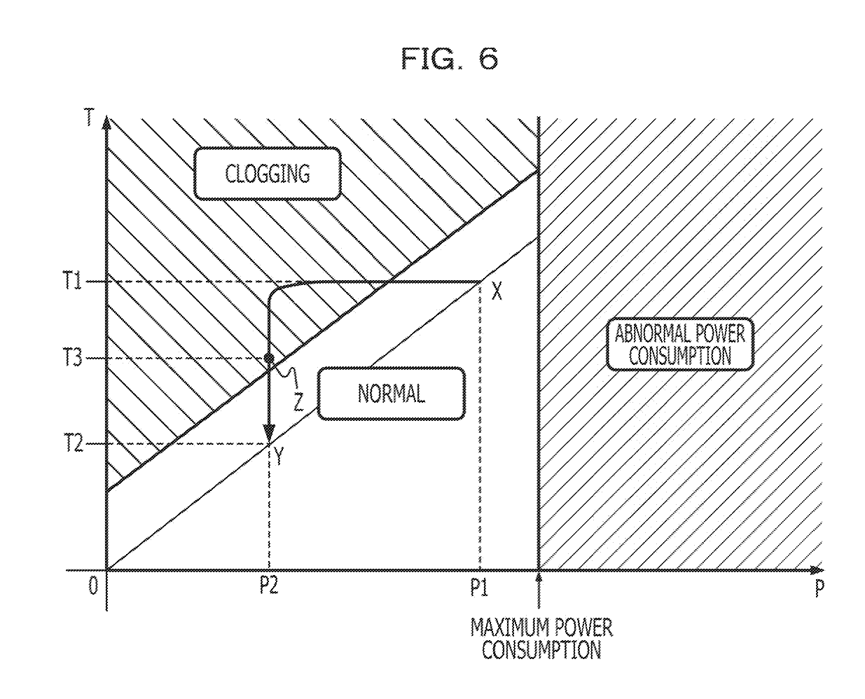

FIG. 6 is a graph showing a relationship between the power consumption P of one PIU 200 and the temperature difference T between the temperature of the PIU 200 and the environmental temperature. Similar to FIG. 4, FIG. 6 illustrates a range where the power consumption is determined to be abnormal, and a range where the filter 410 is determined to be clogged.

Assume that P1 is a power consumption of the PIU 200 in the communication apparatus, and T1 is a temperature difference between the temperature of the PIU 200 and the environmental temperature (see the corresponding point X in FIG. 6). Here, in the PIU 200, the communication apparatus is determined to be normal. Then, for example, assume that the power consumption P1 suddenly drops to a power consumption P2 (P2<P1). Generally, when a power consumption changes in a short time, the speed of change in temperature is slower than the speed of change in power consumption. Therefore, when the power consumption P becomes P2 and the temperature difference T eventually becomes T2, the power consumption P and the temperature difference T move from the point X (FIG. 6) along a path indicated by an arrow to reach a point Y. In this case, as illustrated in FIG. 6, there is a point at which the power consumption is P2 and the temperature difference is T3 (see a point Z in FIG. 6). As is apparent from FIG. 6, when the power consumption is P2 and the temperature difference is T3, the filter 410 is determined to be clogged. However, in this case, although the power consumption P suddenly drops, the filter 410 is not actually clogged. That is, despite the fact that the filter 410 is not clogged, it is possible to erroneously determine that the filter 410 is clogged.

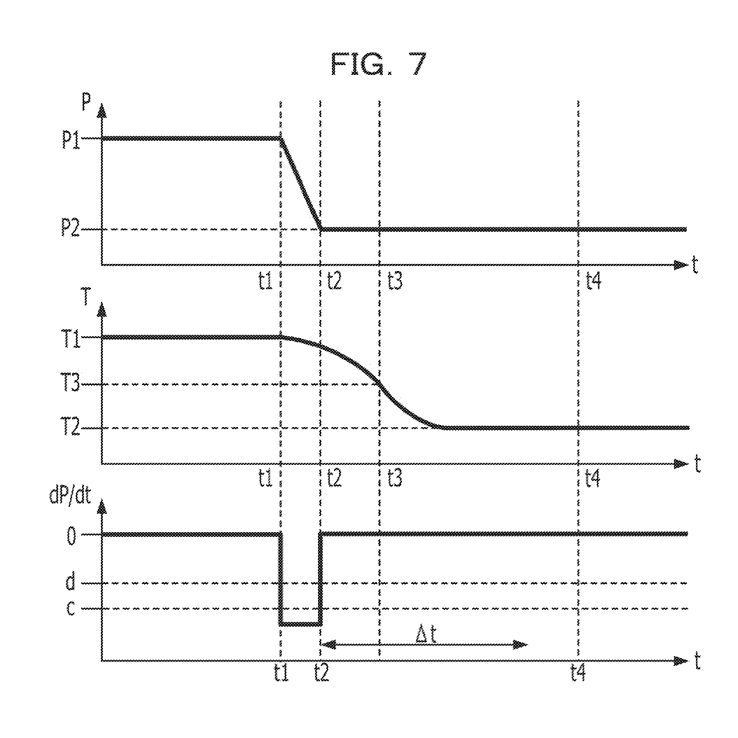

FIG. 7 illustrates how power consumption, temperature difference, and temporal differentiation of power consumption change with time when there is a sudden change in power consumption. The example of FIG. 7 shows temporal changes before and after the change from the point X to the point Y in FIG. 6. The point X, the point Y, and the point Z in FIG. 6 correspond to time t1, time t4, and time t3, respectively, in FIG. 7.

The change from the point X to the point Y in FIG. 6 will now be described with reference to FIG. 7. In the period from time t1 to time t2, the power consumption P suddenly changes from the power consumption P1 to the power consumption P2. On the other hand, the temperature difference T changes from the temperature difference T1 only slightly in the period from time t1 to time t2. The temperature difference T becomes the temperature difference T2 after some time elapses from time t2. At time t3 (>t2) at which the power consumption P is P2, the temperature difference T is T3. As illustrated in FIG. 6, the point Z (corresponding to the power consumption P2 and the temperature difference T3) is within the range where the filter 410 is determined to be clogged.

Therefore, the controller 120 is configured such that if the temporal differentiation of the power consumption P (dP/dt) is less than or equal to a negative value “c” (i.e., if power consumption suddenly drops), the controller 120 does not perform the determination of step S113 in FIG. 3. This is because it is difficult to make an accurate determination immediately after a sudden drop in power consumption. After the temporal differentiation of the power consumption P (dP/dt) is kept greater than or equal to a negative predetermined value “d” for a period of time (Δt) (i.e., after the predetermined period of time (Δt) elapses from time t2), the controller 120 performs the determination of step S113. This is because the temperature difference T is stabilized after the power consumption P is stabilized for a period of time. The negative value “d” may be any value greater than or equal to the negative value “c”. Thus, when there is a sudden drop in power consumption P, it is possible to reduce the likelihood of and/or prevent the controller 120 from erroneously determining that the filter 410 is clogged.

On the other hand, when there is a sudden increase in power consumption P (i.e., the temporal differentiation of the power consumption P is positive), even if the speed of change in temperature is slow, the relationship between the power consumption P and the temperature difference T does not fall within the range where the filter 410 is determined to be clogged.

(Second Modification)

Although the abnormality detecting device 100 is included in the communication apparatus in the examples described above, the abnormality detecting device 100 is present outside the communication apparatus in this example. A description will be mainly given of differences from the examples described above, and a redundant description will be omitted.

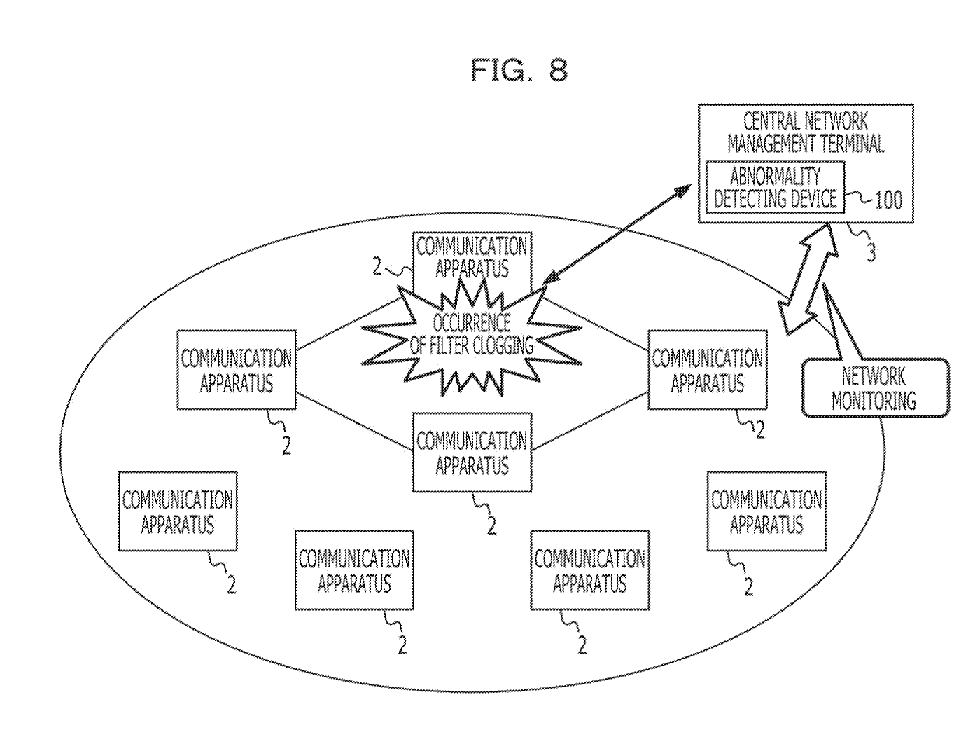

FIG. 8 illustrates an example where a plurality of communication apparatuses each having a filter are managed by a central network management terminal. A plurality of communication apparatuses 2 are connected to each other through communication lines. A central network management terminal 3 centrally manages the plurality of communication apparatuses 2. The central network management terminal 3 includes the abnormality detecting device 100. Each of the communication apparatuses 2 includes the units of the communication apparatus in the above-described examples, except the abnormality detecting device 100.

The abnormality detecting device 100 included in the central network management terminal 3 has a database (determination criteria) for the plurality of communication apparatuses 2. The abnormality detecting device 100 can obtain temperature and other information from each communication apparatus 2, determine whether the filter of the communication apparatus 2 is clogged, and output an alert for the communication apparatus 2.

Thus, since the abnormality detecting device 100 is included in the central network management terminal 3, the central network management terminal 3 can centrally manage the plurality of communication apparatuses 2. Since it is not necessary to mount the abnormality detecting device 100 on each of the communication apparatuses 2, the configuration of each communication apparatus 2 is simplified.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A determining apparatus comprising:
a container to hold a cooled device;
a first temperature detector to detect a temperature inside the container;
a second temperature detector to detect a temperature outside the container;
an air filter to allow air to flow therethrough between the container and a space outside the container;
a fan to facilitate the airflow through the air filter;
a packing density calculator to calculate a packing density of components of the cooled device;
a power consumption detector to detect a power consumption of the cooled device;
a rotational speed detector to detect a number of revolutions of the fan; and
a determining unit to determine that the air filter is clogged when the power consumption is less than or equal to a power threshold value, the number of revolutions is within a specified range, and a difference between the temperature inside the container and the temperature outside the container exceeds a temperature threshold value that depends on the packing density and the power consumption.

2. The determining apparatus according to claim 1, wherein the determining unit stops the determination of a state of the air filter when a temporal differentiation of the power consumption of the cooled device becomes less than or equal to a first negative value, and resumes the determination after the temporal differentiation of the power consumption of the cooled device is kept greater than or equal to a second negative value for a period of time, the second negative value being greater than or equal to the first negative value.

3. A determining method comprising:
holding a cooled device in a container;
detecting a temperature inside the container;
detecting a temperature outside the container;
facilitating a airflow through an air filter that allows air to flow therethrough between the container and a space outside the container;
calculating a packing density of components of the cooled device;
detecting a power consumption of the cooled device;
detecting the number of revolutions of a fan that facilitates the flow of air through the air filter; and
determining that the air filter is clogged when the power consumption is less than or equal to a power threshold value, the number of revolutions is within a specified range, and a difference between the temperature inside the container and the temperature outside the container exceeds a temperature threshold value that depends on the packing density and the power consumption.

4. The determining method according to claim 3, wherein the determination of a state of the air filter is stopped when a temporal differentiation of the power consumption of the cooled device becomes less than or equal to a first negative value, and the determination is resumed after the temporal differentiation of the power consumption of the cooled device is kept greater than or equal to a second negative value for a period of time, the second negative value being greater than or equal to the first negative value.

5. A determining apparatus comprising:
an obtaining unit configured to obtain information from an apparatus that includes a container configured to hold a cooled device, a first temperature detector configured to detect a temperature inside the container, a second temperature detector configured to detect a temperature outside the container, an air filter configured to allow air to flow therethrough between the container and a space outside the container, a fan configured to facilitate the airflow through the air filter, a packing density calculator configured to calculate a packing density of components of the cooled device, a power consumption detector configured to detect a power consumption of the cooled device, and a rotational speed detector configured to detect the number of revolutions of the fan, the information including the packing density, the power consumption of the cooled device, the number of revolutions of the fan, the temperature inside the container, and the temperature outside the container; and
a determining unit configured to determine that the air filter is clogged when the power consumption is less than or equal to a power threshold value, the number of revolutions is within a specified range, and a difference between the temperature inside the container and the temperature outside the container exceeds a temperature threshold value that depends on the packing density and the power consumption.
